(19) United States
(12) Patent Application Publication
(10) Pub. No.: US 2014/0116112 A1
(43) Pub. Date: May 1, 2014

(54) METHODS FOR DETERMINING THE PRESENCE OR ABSENCE OF CONTAMINANTS IN A SAMPLE

(71) Applicant: K & D LABORATORIES, INC., Lake Oswego, OR (US)

(72) Inventors: David Kent HUMPHREY, Reno, NV (US); Nicholas Joseph GEISE, Portland, OR (US)

(73) Assignee: K & D LABORATORIES, INC., Lake Oswego, OR (US)

(21) Appl. No.: 13/830,388

(22) Filed: Mar. 14, 2013

Related U.S. Application Data
(60) Provisional application No. 61/718,607, filed on Oct. 25, 2012.

(51) Int. Cl. G01N 30/72

(52) U.S. Cl. CPC G01N 30/7206
USPC 73/23.37

(57) ABSTRACT

Methods are provided for rapidly determining the presence or absence of large numbers of contaminants in a test sample, such as a raw material intended for use in the preparation of a nutraceutical. The disclosed methods employ gas chromatography-mass spectrometry techniques together with the specific use of software in combination with a database to analyze data collected after ionization of the sample and determine the presence or absence of the contaminants in the sample.

### REFERENCE TO RELATED APPLICATIONS

This application claims priority to U.S. provisional patent application No. 61/718,607, filed Oct. 25, 2012.

### TECHNICAL FIELD

The present disclosure relates to methods for rapidly determining the presence or absence of multiple contaminants in a test sample, such as a raw material intended for use in the preparation of a nutraceutical, using gas chromatography-mass spectrometry techniques.

### BACKGROUND

As the use of nutraceuticals, such as multivitamins and other dietary supplements, has become more commonplace, concerns over the levels of purity, quality, consistency and potency of such supplements have increased. Ensuring that nutritional and dietary supplements are free of contaminants is particularly important when the supplements are intended for use by children and/or individuals with health problems, environmental sensitivities, etc. The US Food and Drug Administration (FDA) regulates dietary supplements as a category of foods and not as drugs, meaning that dietary supplements do not need to be specifically pre-approved by the FDA. In 2007, the FDA implemented a current Good Manufacturing Practices (cGMP) policy in an attempt to ensure that dietary supplements do not contain contaminants or impurities and are accurately labeled. However, the level of non-compliance with the cGMP is very high. Based on audits completed by the FDAs compliance division in 2011 and 2012, it has been estimated that nearly 70% of dietary supplement manufacturers are non-compliant with the cGMP policy. Significant concerns thus remain over the quality of nutritional and dietary supplements on the market today.

Many supplement companies obtain the raw materials for their supplements from a variety of suppliers, and then use those materials to formulate supplements for sale. Over 80% of the raw materials used in nutraceuticals sold in the US come from China and other non-US countries, leading to additional concerns over potential levels of contamination.

Methods that are typically employed to check for contaminants in raw materials, such as those used in nutraceuticals, are time consuming and expensive. There thus remains a need for methods that can rapidly and cost-effectively identify the presence or absence of, and/or determine the levels of, a large number of contaminants in raw materials intended for use in one or more dietary supplements.

### SUMMARY

The present invention provides methods for rapidly and accurately determining the presence or absence of, and/or quantifying the amount of, a large number of contaminants, such as pesticides, in a sample. In certain embodiments, the methods disclosed herein are employed to test for the presence or absence of contaminants, such as pesticides, in raw materials intended for use in nutraceuticals, such as vitamins and dietary supplements. Such raw materials include, but are not limited to, minerals and plant-based materials such as those listed in Table 1, below.

In one embodiment, methods for detecting the presence or absence of a plurality of contaminants in a sample are provided, such methods comprising: (a) extracting the sample with a water-miscible solvent in the presence of a high concentration of salts to provide a sample extract; (b) shaking and centrifuging the sample extract to provide a supernatant; (c) exchanging the water-miscible solvent in the supernatant for an organic, preferably non-water miscible, solvent methylene chloride to provide a treated supernatant; (d) analyzing the treated supernatant using gas chromatography-mass spectrometry (GC-MS) to provide a total ion chromatogram; (e) deconvoluting the total ion chromatogram to provide non-overlapping spectra; and (f) comparing the non-overlapping spectra with standard mass spectra for the plurality of contaminants, wherein the standard mass spectra are contained in a retention time-locked database. In certain embodiments, the water-miscible solvent is selected from the group consisting of: acetonitrile, ethyl acetate or acetone. In a preferred embodiment, the water-miscible solvent is acetonitrile. In certain embodiments, the organic non-water-miscible solvent is selected from the group consisting of: methylene chloride, hexane and toluene. In a preferred embodiment, the non-water-miscible solvent is methylene chloride.

Such methods can be used to quickly detect the presence or absence of at least 50, 100, 150, 200, 250, 300, 350, 400, 450, 500, 550, 600, 650, 700, 750, 800, 850 or 900 contaminants. In certain embodiments, the disclosed methods are employed to detect the presence or absence of a plurality of compounds selected from those listed in Table 2, below.

In one embodiment, an initial analysis is performed to determine whether or not one or more specific contaminants are present in a sample (i.e. to give a simple “yes or no” result). If this initial analysis indicates that the contaminant is indeed present, a second analysis is performed to determine the amount of the contaminant in the sample. In certain embodiments, the second analysis is performed using GC-MS.

### DEFINITIONS

As used herein, the term “deconvolution” refers to a mathematical technique that separates overlapping mass spectra (i.e. overlapping peaks in a total ion chromatogram (TIC)) into clean spectra of individual components.

As used herein, the term “high concentration of salts” refers to an amount of salts sufficient to provide a solution having a percentage composition by mass of salts between 40% and 90%, such as between 50% and 80% or between 60% and 70%. In certain embodiments, the term “high concentration of salts” refers to an amount of salts sufficient to provide a salt solution having approximately 65% composition by mass of salts. In one specific embodiment, the methods disclosed herein employ 4 g MgSO₄, 1 g NaCl, 1 g trisodium citrate dehydrate and 0.5 g disodium hydrogen citrate sesquihydrate in 10 ml of solution.

As used herein, the term “nutraceutical” refers to food, or parts of food, that provide medical or health benefits, including the prevention and treatment of disease, and that are intended for consumption by a human or other mammal. The term nutraceutical encompasses, but is not limited to, dietary supplements including botanicals, vitamins, minerals, co-enzyme Q, carnitine, ginseng, gingko biloba, Saint John's Wort, saw palmetto, prebiotics and probiotics.

As used herein, the term “retention time-locking” refers to the matching of a first set of retention times obtained using a known chromatographic method having a defined set of column parameters and operating parameters to a second set of retention times obtained using a new, different, chromatographic method having a new, different, set of column parameters, wherein the second set of retention times are matched, or locked, to the first set of retention times.

### DETAILED DESCRIPTION

As outlined above, the present disclosure provides rapid and cost-effective methods for detecting the presence or absence of multiple contaminants in a sample, such as raw materials for use in the preparation of a nutraceutical. Prior to analysis using GC-MS, the sample is extracted using a modified QuEChERS (Quick Easy Cheap Effective Rugged Safe) technique described in detail below. QuEChERS is a method for testing for pesticides that was developed by Michelangelo Anastassiades (Anastassiades et al., J. AOAC Int., 86:412-431 (2003)). This method entails solvent extraction of samples with acetonitrile, ethyl acetate or acetone, and partitioning with magnesium sulfate, either alone or in combination with other salts followed by clean-up using dispersive solid phase extraction (DSPE). More specifically, the sample is first extracted with a water-miscible solvent, such as acetonitrile, in the presence of a high concentration of salts (e.g. sodium chloride and magnesium sulfate) and buffering agents (e.g. citrate) to induce liquid separation and stabilize acidic and basic labile pesticides, respectively. After shaking and centrifugation, an aliquot of the organic phase is subjected to further clean up using DSPE. The resulting mixture is centrifuged and the resulting supernatant can either be analyzed directly or subjected to a concentration and solvent exchange step, if necessary, prior to analysis.

The extracted samples are then subjected to GC-MS analysis using methods well known to those of skill in the art and described below. The total ion chromatogram is deconvoluted as necessary using publicly available software, such as AMDIS (Automated Mass Spectral Deconvolution and Identification System; available from the National Institute of Standards and Technology (NIST)), Chemstation™ and/or DRS (Agilent Technologies, Inc. Santa Clara, Calif.).

The resulting spectra are compared with standard mass spectra for the contaminants of interest that are contained within a database that includes internal calibrations, such as a retention time-locked (RTL) database. Methods for automated retention time-locking are known in the art and include, for example those taught in U.S. Pat. No. 5,987,959. In certain embodiments, the resulting spectra are compared with those contained in a RTL pesticide database, such as the RTL Pesticide Library available from Agilent Technologies, Inc. This database contains locked retention time, compound name, CAS number, molecular weight and mass spectrum for 927 compounds, including pesticides, metabolite and endocrine disrupters, and other known contaminants. Using a RTL database eliminates the need to re-calibrate the GC-MS system for each potential contaminant and thus significantly reduces the time required to test a sample for the presence or absence of multiple contaminants.

Raw materials that can be analyzed using the methods disclosed herein include, but are not limited to, those shown in Table 1, below.

TABLE 1

Acetyl L-Carnitine HCL
Adipic Acid FCC
Alpha Ketoglutaric Acid
Ascorbic Acid (Vit. C-90)
Ascorbic Acid (Vit. C-90)
Ascorbic Acid Crystals (Vit. C)
Astragalus Root Extract Powder
Beta Carotene
Beta Carotene 10%
Beta Carotene 20%
Calcium Alpha Ketoglutarate
Calcium Caprylate
Calcium Carbonate Granular
Calcium Carbonate Powder
Calcium Carbonate Powder(CE Low Lead)
Calcium Citrate Powder
Calcium Citrate Tetrahydrate Granular
Calcium D-Glucarate
Calcium Folinate (Folinic Acid)
Calcium Glycinate Chelate
Calcium Magnesium Phytate
Calcium Pantothenate (B-5)
Choline Dihydrogen Citrate
Citric Acid Anhydrous Granular
Citric Acid Anhydrous Powder
Cobamamide (Vit. B-12 Coenzyme)
Cod Liver Oil (Vitamin A Assay)
Coenzyme Q10
Cupric Oxide
Cyanocobalamin Crystals (Vit. B-12)
D-Biotin 1%
D-Biotin Pure
DHEA (Dehydroepiandrosterone)
Di-Calcium Phosphate Dihydrate
Di-Calcium Phosphate Powder
Di-magnesium Malate Granular
Dimethylaminoethanol (DMAE)
Dimethylglycine HCL (DMG)
Disodium EDTA
Elderberry PE
Ferrous Fumarate
Folic Acid 10% Trituration
Folic Acid USP
GABA
Glucosamine Sulfate Potassium Chloride
Glycine USP
Golden Seal Extract
Grape Seed Extract
Grapefruit Seed Powdered Extract
Idebenone
Inositol Granular
Inositol Hexanicotinate
Iron Amino Acid Chelate (Ferrochel)
Iron Choline Citrate Powder
L-Arginine HCL
L-Asparagine Monohydrate FCC
L-Carnosine
L-Creatine Monohydrate
L-Glutamine
L-Glutamine
L-Glutathione Reduced
Lipoic Acid
L-Isoleucine
Lithium Citrate
L-Leucine
L-Lysine Mono HCL
L-Methionine
L-Phenylalanine
L-Proline
L-Serine
L-Threonine
L-Tyrosine
L-Valine
Magnesium Alpha Ketoglutarate
Magnesium Ascorbate
Magnesium Chloride Hexahydrate
Magnesium Citrate
Magnesium Citrate Anhydrous
Magnesium Citrate Tribasic
Magnesium Glycinate Buffered
Magnesium Oxide Powder
Magnesium Oxide USP
Magnesium Stearate
Magnesium Sulfate USP
Magnesium Taurinate
Manganese Citrate
Manganese Sulfate Monohydrate
Marshmallow Root
Melatonin
Mesodimercaptosuccinic Acic (DMSA)
Methylcobalamin (Vit. B-12)
Methylcobalamin (Vit. B-12) 1% Trit in DCP
Methylcobalamin (Vit. B12) Pure
Methylparaben
Milk Thistle Powder
N-Acetyl Glucosamine
N-Acetyl L-Cysteine
Natural Beta Carotene in Sunflower
Niacinamide (Vit. B3) Rocoat
Niacinamide Granular USP (Vit. B-3)
Olive Leaf Extract
Oregano Extract
Para Amino Benzoic Acid (PABA)
Pau D′ Arco Bark Extract
Potassium Ascorbate Powder
Potassium Iodide
Potassium Sorbate
Propylparaben
Pycnogenol Extract
Pyridoxal-5-Phosphate (P5P)
Pyridoxine (Vit. B-6) HCL Powder
Pyridoxine HCL (Vit. B6) Granular
Pyrodoxine HCL (Vit. B-6) Rocoat
Quercetin Dihydrate
Resveratrol
Riboflavin (Vit. B-2) Phosphate
Riboflavin (Vit. B-2) Rocoat
Riboflavin USP (Vit. B-2)
Slippery Elm Bark
Sodium Ascorbate Crystalline
Sodium Ascorbate Powder
Sodium Benzoate Powder NF/FCC
Sodium Citrate Dihydrate
Sodium CMC
Sodium Fluoride USP
Stearic Acid (Veg. Grade)
Stevia Leaf Extract
Taurine (Ajinomoto)
Taurine (Pharmline)
Thiamine (Vit. B-1) Mononitrate
Thiamine HCL Powder USP
Thiamine Mononitrate (Vit. B-1) Rocoat
Thiamine Mononitrate Powder (Vit. B-1)
Trimethylglycine Powder (TMG)
Turmeric Root Extract
Vitacel
Vitamin A Acetate
Vitamin A Palmitate
Vitamin B-12 1% Trit in Mannitol
Vitamin D-3 100 MIU/g
Vitamin D-3 Pure
Vitamin E Acetate 50%
Vitamin E Acetate 75%
Vitamin E Acetate Oil
Vitamin K-1 5% SD, Dry
Zinc Amino Acid Chelate
Zinc Citrate Dihydrate
Zinc Ketoglutarate
Zinc Picolinate Powder
Zinc Sulfate

Table 2 shows a list of potential contaminants that can be detected using the methods disclosed herein, as published in Wylie, “Screening for 926 Pesticides and Endocrine Disruptors by GC/MS with Deconvolution Reporting Software and a New Pesticide Library” Application Note, Agilent Technologies, Inc., 2006.

TABLE 2

1,2,4-Trichlorobenzene
1,2-Dibromo-3-chloropropane
1,3,5-Tribromobenzene
1,3-Dichlorobenzene
17a-Ethynylestradiol
1-naphthalenol
2-(1-naphthyl)actamido
2-(2-Butoxyethoxy)ethyl thiocyanate
2-(Octylthio)ethanol
2,3,4,5-Tertrachloronitrobenzene
2,3,4,5-Tetrachlorophenol
2,3,4,6-Tetrachlorophenol
2,3,5,6-Tetrachlorophenol
2,3,5,6-Tetrachloro-p-terphenyl
2,3,5-Trichlorophenol
2,3,5-Trimethacarb
2,3,6-Trichloroanisole
2,3,7,8-Tetrachlorodibenzofuran
2,3,7,8-Tetrachlorodibenzo-p-dioxin
2,4,5,6-Tetrachloro-m-xylene
2,4,5-T methyl ester
2,4,5-Trichloroaniline
2,4,5-Trichlorophenol
2,4,5-Trichloro-p-terphenyl
2,4,5-Trimethylaniline
2,4,6-Tribromoanisole
2,4,6-Tribromophenol
2,4,8-Trichloroanisoln
2,4,8-Trichlorophenol
2,4-D methyl ester
2,4-D sac-butyl ester
2,4-DB methyl ester
2,4′-Dichlorobenzophenone (2,4′-Dicalol
decomposition product)
2,4-Dichlorophenol
2,4-Dichlorophenyl benzenesulfonate
2,4-Dimethylaniline
2,4-Dimethylphenol
2,8-Dichlorobenzamide
2,8-Dichlorobenzonitrile
2,6-Dimethylaniline
2-[3-Chlorophenoxy]propionamide
2-Chlorophenol
2-Ethyl-1,3-hexanediol
2-ethyl-8-methylaniline
2-Hydroxyestradiol
2-Methyl-4,6-dinitrophenol
2-Methylphenol
2-Nitrophenol
2-Phenoxypropionic acid
3,4,5-Trimethacarb
3,4-Dichloroaniline
3,4-Dichloroaniline
3-Aminophenol
3-Chloro-4-fluoroaniline
3-Chloro-4-methoxyaniline
3-Chloroaniline
3-Hydroxycarbofuran
3-Indolylacetonitrile
3-Trifluormethylaniline
4,4′-Dichlorobenzophenone
4,4′-Oxydianiline
4,6-Dinitro-o-cresol (DNDC)
4-Aminodiphenyl
4-Bromoaniline
4-Chloro-2-methylaniline
4-Chloro-3-methylphenol
4-Chloroaniline
4-Chlorophenyl-isocyanate
4-Isopropylaniline
4-Methylphenol
4-Nitrophenol
4-Nonylphenol
5,7-Dihydroxy-4′-methoxyisoflavone
9,10-Anthraquinone
Acenaphthane
Acenaphthylene
Acephate
Acequinocyl
acetamiprid
Acetochlor
Acifluorfen methyl ester
Aclariffen
Accinathrin
Alachlor
Aldrin
Allidochlor
Amelyn
Amidithion
Aminocarb
Amitraz
Amitraz metabolite [Methanimidamide, N-
(2,4-dimethylphenyl)-N′-methyl-]
Ancymidol
Anilazine
Aniline
Anilofos
Anthracene
Aramite I
Aramite II (CAS # 140-57-8)
Atraton
Atrazine
Atrazine-desethyl
Azaconazole
Azamethiphos
Azibenzolar-S-methyl
Azinphos-ethyl
Azinphos-methyl
Aziprotryn metabolite [2-Amino-
4-isopropylamino-6-methylthio-
1,3,5-triazine]
Aziprotryne
Azobenzene
Azoxybenzene
Azoxystrobin
Barben
Bellubutamid
Benalaxyl
Benazolin-ethyl
Bendiocarb
Benfluralin
Benfuracarb
Benferesate
Benetanil
Benoxacor
Bentazone
Bentazone methyl derivative
Benthiocarb
Benzene, 1,3-bis(bromomethyl)-
Benzenesulfonamide
Benzidine
Benzo(a)anthracene
Benzo(a)pyrene
Benzo[b]fluoranthene
Benzo[g,h,i]parylene
Benzo[k]fluoranthene
Benzophenone
Benzoximate metabolite
Benzoylprop ethyl
Benzyl benzoate
b-Estradiol
BHC alpha isomer
BHC beta isomer
BHC delta isomer
BHC epsilon isomer
Bifenazate metabolite
(5-Phenyl-o-anisidine)
Bifenox
Bifenthrin
Binapacryl
Bioallethrin
Bioallethrin S-cyclopentenyl isomer
Bioresmethrin
Biphenyl
Bis(2,3,3,3-tetrachloropropyl) ether
Bis(2-butoxyethyl) phthalate
Bis(2-ethylhexyl)phthalate
Bisphenol A
Bitertanol I
Bitertanol II (CAS # 55179-31-2)
Boscalid (Niobifan)
Bromocil
Bromfenvinphos-(E)
Bromfenvinphos-(Z)
Bromobutide
Bromocyclan
Bromophos
Bromophos-ethyl
Bromopropylate
Bromoxynil
Bromoxynil octanoic acid ester
Bromoconazole I
Bromoconazole II (CAS # 116255-48-2)
Bufencarb
Bupiliniate
Buprofezin
Butachlor
Butafenacil
Butamilos
Butoxycarboxim
Butralin
Butyl benzyl phthalate
Butylate
Butylated hydroxyanisole
Cadusafos
Cafenstrole
Caffeine
Captafol
Captan
Carboryl
Carbetamide
Carbofuran
Carbofuran-3-keto
Carbofuran-7-phenol
Carbophenethion
Carbosulfen
Carboxin
Carfentrazone-ethyl
Carpropamid
Carvone
Cashmeran
Cekalix
Celestolide
Chinomethionet
Chloramben methyl ester
Chloronocryl
Chlorbenside
Chlorbenside sulfone
Chlorbicyclen
Chlorbromuron
Chlorbulam
Chlordecone
Chlordene, trans-
Chlordimeform
Chlorethoxyfos
Chlorfenapyr
Chlorfenethol
Chlorfenprop-methyl
Chlorfenson
Chlorfenvinphos
Chlorfenvinphos, cis-
Chlorfenvinphos. trans-
Chlorflurecol-methyl ester
Chlormefos
Chlomitrofen
Chlorobenzilate
Chloraneb
Chloropropylate
Chlorothalonil
Chlorotoluron
Chlorpropham
Chlorpyrifos
Chlorpyrifos Methyl
Chlorthal-dimethyl
Chlorthiamid
Chlorthion
Chlorthiophos
Chlorthiophos sulfone
Chlorthiophos sulfoxide
Chlozolinate
Chrysene
Cinerin I
Cinerin II
Cinidon-ethyl
cis-Chlodane
Clodinafop-propargyl
Clornazone
Cloquintocet-methyl
Coumaphos
Crinkline
Crotoxyphos
Crufomate
Cyanazine
Cyanofenphos
Cyanophos
Cyclafuramid
Cycloate
Cyclopentadecanone
Cycluron
Cyllufenamid
Cylluthrin I
Cyllurhrin II (CAS # 68359-37-5)
Cylluthrin III (CAS # 68359-37-5)
Cylluthrin IV (CAS # 68359-37-5)
Cyhalofop-butyl
Cyhalothrin I (lambda)
Cyhalothrin (Gamma)
Cymiazole
Cymoxanil
Cypermethrin I
Cypermethrin II (CAS # 52315-07-8)
Cypermethrin III (CAS # 52315-07-8)
Cypermethrin IV (CAS # 52315-07-8)
Cyphenothrin cis-
Cyphenothrin trans-(CAS # 39515-40-7)
Cyprazine
Cyproconazole
Cyprodinil
Cyprofuram
Cyromazine
d-(cis-trans)-Phenothrin-I
d-(cis-trans)-Phenothrin-II
(CAS # 260002-80-2)
Dazomet
DDMU [1-Chloro-2,2-bis(4′,chlorophenyl])
Decachlorobiphenyl
Deltamethrin
Demaphion
Demeton-S
Demeton-S-methylsulfon
Desbromo-bromobutide
Desmediphan
Desmetryn
Dialifos
Di-allato I
Di-allate II (CAS # 2303-16-4)
Diamyl phthalate
Diazinon
Diazinon-oxon
Dibenz[a,b]anthracene
Dicamba
Dicamba methyl ester
Dicapthon
Dichlofenthion
Dichlofluanid
Dichlofluanid metabolite (DMSA)
Dichlone
Dichlormid
Dichlorophen
Dichlorprop
Dichlorprop methyl ester
Dichlorves
Diclobutrazol
Diclocymet I
Diclocymet II (CAS # 139920-32-4)
Diclofop methyl
Dicloran
Dicrotophos
Dicyclohexyl phthalate
Dicyclopentadieno
Dieldrin
Diethatyl ethyl
Diethofencarb
Diethyl dithiobis(thionoformate) (EXD)
Diethyl phthalate
Diethylene glycol
Diethylstilbestrol
Difenoconazol I
Difenoconazol II (CAS # 119446-68-3)
Difenoxuton
Diflufenican
Diisobutyl phthalate
Dimelox
Dimepiperate
Dimethachlor
Dimethametryn
Dimethenomid
Dimethipin
Dimethoate
Dimethomorph-(E)
Dimethomorph-(Z) (CAS # 110488-70-5)
Dimethylphthalate
Dimethylvinphos(z)
Dimetilan
Dimoxystrobin
Di-n-butylphthalate
Di-n-hexyl phthalate
Diniconazole
Dinitramine
Di-n-nonyl phthalate
Dinobuton
Dinocap I
Dinocap II (CAS # 39300-45-3)
Dinocap III (CAS # 39300-45-3)
Dinocap IV (CAS # 39300-45-3)
Di-n-octyl phthalate
Dinoseb
Dinoseb acetate
Dinoseb methyl ether
Dinoterb
Dinoterb acetate
Di-n-propyl phthalate
Diofenolan I
Diofenolan II (CAS # 63837-33-2)
Dioxabenzofos
Dioxacarb
Dioxathion
Diphacinone
Diphenamid
Diphenyl pththalate
Diphenylamine
Dipropetryn
Dipropyl isocinchomeronate
Disulfoton
Disulfoton sulfone
Ditalimfos
Dithiopyr
Diuron
Diuron Metabolite [3,4-Dichlorophenyl
isecyanate]
Dodemorph I
Dodemorph II (CAS # 1593-77-7)
Drazoxolon
Edifenphos
Empenthrin I
Empenthrin II (CAS # 54406-48-3)
Empenthrin III (CAS # 54408-48-3)
Empenthrin IV (CAS # 54406-48-3)
Empenthrin V (CAS # 54406-48-3)
Endosulfan (alpha isomer)
Endosulfan (beta isomer)
Endosulfan ether
Endosulfan lactone
Eadosulfan sulfate
Endrin
Endrin aldehyde
Endrin ketone
EPN
Epoxiconazole
EPTC
Erbon
Esfenvalarate
Esprocarb
Etaconazole
Ethalfluralin
Ethidimuron
Ethiofencarb
Ethiolate
Ethion
Ethofenprox
Ethofumesate
Ethofumesate, 2-Keto
Ethoprophos
Ethoxyfen-ethyl
Ethoxyquin
Ethylenethiourea
Etoxazole
Etridiazole
Etridiazole, deschloro-(5-ethoxy-
3-dichloromethyl-1,2,4-thiadiazole)
Etrimfos
Eugenol
Exaltolida (1,5-Pentadecanolide)
Famoxadon
Famphur
Fenamidone
Fenamiphos sulfoxide
Fenamiphos-sulfone
Fenarimol
Fenazaflor
Fenazaflor metabolite
Fenazaquin
Fenbuconazole
Fenchlorazole-ethyl
Fenchlorphos
Fenchlorphos-oxon
Fenclarim
Fenfuram
Fenhexamid
Fenitrothion
Fenitrothion-oxon
Fenobucarb
Fenoprop
Fenoprop methyl ester
Fenothiocarb
Fenoxanil
Fenoxaprop-ethyl
Fenoxycarb
Fenpiclonil
Fenpropathrin
Fenpropidin
Fenson
Fensulfothion
Fensulfothion-oxon
Fensulfothion-oxon-sulfone
fensulfothion-sulfone
Fenthion
Fenthion sulfoxide
Fenthion-sulfone
Fenuron
Fenvalerate I
Fenvalerate II (CAS # 51630-58-1)
Fepropimorph
Fipronil
Fipronil, desulfinyl-
Fipronil-sulfide
Fipronil-sulfona
Flamprop-isoprppyl
Flamprop-methyl
Fluacrypyrim
Fluazilop-p-butyl
Fluazinam
Fluazolate
Flubenzimine
Fluchloralin
Flucythrinate I
Flucythrinate II (CAS # 70124-77-5)
Fludioxonil
Flufenacot
Flumetralin
Flumiclorac-pentyl
Flumioxazin
Fluometuron
Fluoranthane
Fluorane
Fluorodifen
Fluoroglycofen-ethyl
Fluoroimide
Fluotrimazole
Fluoxastrobin cis-
Fluquinconazole
Flurenol-butyl ester
Flurenol-methylester
Fluridone
Flurochloridone I
Flurochloridone II (CAS # 61213-25-0)
Flurochloridone, deschloro0
Fluroxypyr-1-methylheptyl ester
Flurprimidol
Flurtamone
Flusilazole
Fluthiacat-methyl
Flutolanil
Flutrialol
Fluvalinate-tau-I
Fluvalinate-tau-II (CAS # 102851-06-9)
Folpet
Fonofos
Formothion
Fosthiazate I
Fosthiazate II (CAS # 98888-44-3)
Futheridazole
Furalaxyl
Furathiocarb
Furilazole
Furmacyclox
Halfenprox
Haloxyfop-methyl
Heptachlor
Heptachlor epoxide isomer A
Heptachlor exo-epoxide isomer B
Heptenophos
Hexabromobenzene
Hexachlorobenzene
Hexachlorophene
Hexaconazole
Hexazinone
Hexestrol
Hydroprene
Imazaill
Imazamethabenz-methyl I
Imazamethabenz-methyl II
(CAS # 81405-85-8)
Imibenconazole
Imibenconazole-desbenzyl
Indeno[1,2,3-cd]pyrene
Indoxacarb and Dioxacarb decomposition
product [Phenol, 2-(1,3-dioxolan-2-yl)-]
Ioxynil
Ioxynil octanoate
Ipconazole
Iprohenfos
Iprodiene
Iprovalicarb I
Iprovalicarb II (CAS # 140923-25-7)
Irgarol
Isazophos
Isobenzon
Isobornyl thiocyanoacetate
Isocarbamide
Isocarbophos
Isodrin
Isofenphos
Isofenphos-oxon
Isomethiozin
Isoprocarb
Isopropalin
Isoprothiolane
Isoproturon
Isoxaben
Isoxadifen-ethyl
Isoxaflutole
Isoxathion
Jasmolin I
Jasmolin II
Jodfenphos
Kinoprene
Kresoxim-methyl
Lactolen
Lenacil
Leptophos
Leptophos oxon
Lindane
Linuron
Malathion
Malathion-o-analog
MCPA methyl ester
MCPA-butoxyethyl ester
MCPB methyl ester
m-Cresol
Mecarbam
Mecoprop methyl ester
Mefenacet
Mefenpyr-diethyl
Melluidide
Menazon
Mepanipyrim
Mephosfalen
Mepronil
Metalaxyl
Metamitron
Metasystox thiol
Metazachlor
Metconazole I
Metconazole II (CAS # 125116-23-6)
Methabenzthiazuron [decomposition
product]
Methacrilos
Methamidophos
Methfuroxam
Methidathion
Methiocarb
Methiocarb sulfone
Methiocarb sulfoxide
Methomyl
Methoprene I
Methoprene II (CAS # 40596-69-8)
Methoprotryne
Methoxychlor
Methoxychlor olelin
Methyl (2-naphthoxy)acetate
Methyl paraoxon
Methyl parathion
Methyl-1-naphthalene acetate
Methyldymron
Metobromuron
Metolachlor
Metolcarb
Metominostrobin (E)
Metominostrobin (Z)
(CAS # 133408-50-1)
Metrafenone
Metribuzin
Mevinphos
Mirex
Molinate
Monalide
Monocrotophos
Monolinuron
Musk amberalta
Musk Ketone
Musk Moskene
Musk Tibetene (Moschustibeten)
Musk xylene
Myclobutanil
N,N-Diethyl-m-toluamide
N-1-Naphthylacetamide
Nalad
Naphthalene
Naphthalic anhydride
Naproanilide
Napropamide
Nicotine
Nitralin
Nitrapyrin
Nitrofen
Nitrothal-isopropyl
N-Methyl-N-1-naphthyl acetamide
Nonachlor, cis-
Nonachlor, trans-
Norflurazon
Norflurazon, desraethyl-
Nuarimol
o.p′-DDD
o.p′-DDE
o.p′-DDT
Octachlorostyrene
o-Dianisidine
o-Dichlorobenzene
Ofurace
Omethoate
o-Phenylphenol
Orbencarb
ortho-Aminoazotoluene
Oryzalin
Oxabetrinil
Oxadiazon
Oxadixyl
Oxamyl
Oxycarboxin
Oxychlordane
Oxydemeton-methyl
Oxyfluorfen
p.p′-DDD
p.p′-DDE
p.p′-DDM [bis(4-chlorophenyl)methane]
p.p′-DDT
p.p′-Dibromobenzophenone
p.p′-Dicofol
Paclobutrazol
Paraoxon
Parathion
PBB 52 Tetrabrombiphenyl
PBB 101
PBB 15
PBB 169 Hexabrombiphenyl
PCB 101
PCB 105
PCB 110
PCB 118
PCB 126
PCB 127
PCB 131
PCB 136
PCB 138
PCB 153
PCB 169
PCB 170
PCB 180
PCB 30
PCB 31
PCB 49
PCB 77
PCB 81
p-Dichlorobenzene
Pebulate
Penconazole
Pendimethalin
Pentachloroaniline
Pentachloroanisole
Pentachlorobenzene
Pentachloronitrobenzene
Pentachlorophenol
Pentanochlor
Permethrin I
Permethrin II (CAS # 52645-53-1)
Perthane
Phantolide
Phenamiphos
Phenanthrene
Phenanthrene-d10
Phenkapton
Phenol
Phenothiazine
Phenothrin I
Phenothrin II
Phenoxyacetic acid
Phenthoate
Phorate
Phorate sulfone
Phorate sulfoxide
Phorata-oxon
Phosalone
Phosfolan
Phosmet
Phosphamidon I
Phosphamidon II (CAS # 13171-21-6)
Phthalide
Phthalimide
Picloram methyl ester
Picolinefen
Picoxystrobin
Pindone
Piperalin
Piperonyl butoxide
Piperophos
Pirimicarb
Pirimiphos-ethyl
Pirimiphos-methyl
Plifenat
p-Nitrotoluene
Potasan
Prallethrin, cis-
Prallethrin, trans-(CAS # 23031-36-9)
Pretilachlor
Probenazole
Prochloraz
Procymidone
Prodiamine
Profenofos
Profenofos metabolite (4-Bromo-
2-chlorophenol)
Profluralin
Prohydrojasmon I
Prohydrojasmon II (CAS # 158474-72-7)
Promecarb
Promecarb artifact [5-isopropyl-
3-methylphenol]
Prometon
Prometryn
Propachlor
Propamocarb
Propanil
Propaphos
Propargite
Propargite metabolite (Cyclohexanol,
2-(4-tert-butylphenoxy)]
Propazine
Propetamphos
Prophem
Propiconazole-I
Propiconazole-II (CAS # 80207-90-1)
Propisochlor
Propoxur
Propyzamide
Prosulfocarb
Prothioconazofe-dosthio
Prothiofos
Prothoate
Pyracarbolid
Pyraclofos
Pyraflufen-ethyl
Pyrazon
Pyrazophos
Pyrazoxyfen
Pyrene
Pyrethrin I
Pyrethrin II
Pyributicarb
Pyridaben
Pyridaphenthion
Pyridate
Pyridinitril
Pyrifenox I
Pyrifenox II (CAS # 88283-41-4)
Pyriltalid
Pyrimethanil
Pyrimidifen
Pyriminobac-methyl (E)
Pyriminobac-methyl (Z)
(CAS # 136191-64-5)
Pyriproxyfen
Pyroquilon
Quinalphos
Quinoclamine
Quinoxyfen
Quintozene metabolite (pentachlorophenyl
methyl sulfide)
Quinzalofop-ethyl
Rabenzazole
Resmethrin
Resmethrine I
Resmethrine II (CAS # 10453-86-8)
Rotenone
S,S,S-Tributylphosphorotrithioate
Schradan
Sebuthylazine
Sebuthylazine-desethyl
Secbumeton
Silafluofen
Silthiopham
Simazine
Simeconazole
Simetryn
Spirodiclofen
Spiromesifen
Spiroxamine I
Spiroxamine II (CAS # 118134-30-8)
Spioxamine metabolite (4-tert-butylcyclo-
hexanone)
Sudan I
Sudan II
Sudan Red
Sulfallate
Sulfanilamide
Sulfentrazone
Sulfotep
Sulfur (SB)
Sulprofos
Swep
Tamoxifen
TCMTB
Tebuconazole
Tebufenpyrad
Tebupirimifos
Tebutam
Tabuthiuron
Tecnazene
Tefluthrin, cis-
Temephos
Terbacil
Terbucarb
Terbufos
Terbufos-oxon-sulfone
Terbufos-sulfone
Terbumeton
Terbuthylazine
Terbuthylazine-desethyl
Terbutryne
Tetrachlorvinphos
Tetraconazole
Tetradifon
Tetraethylpyrophosphate (TEPP)
Tetrahydrophthalimide, cis-1,2,3,6-
Tetramethrin I
Tetramethrin II (CAS # 7696-12-0)
Tetrapropyl thiodiphosphate
Tetrasul
Thenylchlor
Theobromine
Thiabendazole
Thiazopyr
Thifluzamide
Thiofanox
Thiomeron
Thionazin
Thymol
Tiocarbazil I
Tiocarbazil II (CAS # 36756-79-3)
Tolclofos-methyl
Tolfenpyrad
Tolylfluanid
Tolylfluanid metabolite (DMST)
Tolyltriazole [1H-Benzotriazole, 4-methyl-]
Tolyltriazole [1H-Benzotriazole, 5-methyl-]
Tonalide
Toxaphene Parlar 26
Toxaphene Parlar 50
Toxaphene Parlar 62
trans-Chlordane
Transfluthrin
Trassalide
Triadimefon
Triadimenol
Tri-allate
Triamiphos
Trispenthenol
Triazamate
Triazophos
Tributyl phosphate
Tributyl phosphorotrithioite
Trichlamide
Trichlorfon
Trichloronate
Triclopyr methyl ester
Triclosan
Triclosan-methyl
Tricresylphosphate, meta-
Tricresylphosphate, ortho-
Tricresylphosphate, para
Tricyclazole
Tridemorph, 4-tridecyl-
Tridiphane
Trietazine
Triethylphosphate
Trilenmorph
Trilloxystrobin
Trillumizole
Trilluralin
Triphenyl phosphate
Tris(2-butoxyethyl) phosphate
Tris(2-chloroethyl) phosphate
Tris(2-ethylhexyl) posphate
Triticonazole
Tryclopyrbutoxyethyl
Tycor (SMY 1500)
Uniconizole-P
Vamidithion
Vernolate
Vinclozolin
XMC (3,4-Dimethylphenyl
N-methylcarbama
XMC (3,5-Dimethylphenyl
N-methylcarbama
Zoxamide
Zoxamide decomposition product

The following examples are intended to illustrate, but not limit, this disclosure.

### EXAMPLES

### Materials and Methods

### 1. Preparation of Samples for GC/MS Analysis

Approximately 1.0 g of sample was placed in a 50 mL tube and the exact weight was recorded on a log sheet. For each sample, two quality control samples were prepared using 1 g muffled sand; these were labeled “MB” (Method Blank) and “LCS” (Laboratory Control Sample). 9.0 mL of deionized water was added to each of the tubes. Quality control standards were added as follows:

(a) 50 uL of 20 ppm GC surrogate (tetrachlorometaxylene (TCMX), Decachlorobiphenyl (DCB), Tributyl phosphate and Triphenyl phosphate) in acetonitrile was added to all samples including the MB and LCS;

(b) 100 uL of 20 ppm OC pest spiking solution (Organochlorine Pesticide Mix AB #1 (Restek Corp., Bellefonte, Pa.) containing aldrin, α-BHC, β-BHC, δ-BHC, γ-BHC (lindane), cis-chlordane, trans-chlordane, 4,4′-DDD, 4,4′-DDE, 4,4′-DDT dieldrin, endosulfan I, endosulfan II, endosulfan sulfate, endrin, endrin aldehyde, endrin ketone, heptachlor, heptachlor epoxide (isomer B) and methoxychlor) in acetonitrile was added to the LCS; and

(c) 100 uL of 20 ppm Internal Standard solution in acetonitrile was added to all samples.

The samples were shaken vigorously and allowed to equilibrate for 2 hours at room temperature. Extraction of the samples was then performed by adding 10 mL of acetonitrile and shaking for one minute, adding the contents of an extraction salt packet (Q-Sep™ Q110 QuEChERS extraction salt packet containing 4 g MgSO₄, 1 g NaCl, 1 g trisodium citrate dehydrate, 0.5 g disodium hydrogen citrate sesquihydrate; Restek Corp.), shaking again for one minute and then centrifuging for 5 minutes.

For samples needing clean-up (as determined for example, by previous difficulties with analysis, difficult matrix or darkly colored residues), the solvent extract was placed in a cleanup tube (Q-Sep™ dSPE 15 mL sample cleanup centrifuge tubes containing 900 mg MgSO4, 150 mg PSA and 45 mg GCB), shaken vigorously and centrifuged for 5 minutes, before being placed in an evaporation tube. The samples were then evaporated to near dry (less than 1 mL solvent) using a TurboVap™ evaporator, and 5 mL methylene chloride was added using a solvent pump. This process was repeated until the acetonitrile portion had been exchanged out for methylene chloride and the volume had reached less than 1 mL. Methylene chloride was then added to raise the volume in the sample back to 1 mL, and the sample was transferred into a labeled vial and cap using a crimper and aluminum cap.

Blanks were run with every set of samples to ensure that laboratory media or equipment was not leading to false positives in any contaminants. These were made following the same process as for the extracts for analysis.

### 2. GC/MS Analysis

Samples prepared as described above were analyzed for the presence of contaminants using an Agilent Technologies 5975C gas chromatograph/mass spectrometer (GC/MS) in combination with enhanced data analysis as described below.

Prior to analysis of samples, the GC/MS was checked for any instrument problems that could seriously affect the quality of analysis using routine procedures well known to those of skill in the art. Each analysis sequence carried out on the GC/MS was bracketed by calibration verification samples, “initial calibration verification” samples or “continuing calibration verification” samples. These samples were made using concentrations equal to 0.1 ppm. The concentration of the standards in these samples was within 50% of the expected values. The method blank (MB) and laboratory control (LCS) samples were placed at the beginning of the sequence.

The instrument was calibrated for target analytes, or contaminants, prior to reporting any target analyte concentration. Calibration was performed by running a set of samples containing a blank and five known concentrations, with the highest level corresponding to the highest expected results, through the screening method. The calibration set was quantitated using data analysis and deconvolution employing Deconvolution Reporting Software (DRS; Agilent Technologies, Inc). After each of the five calibration samples were quantitated, the new values were entered into the database. The curve shapes were checked for linearity. R̂2 values were 0.98 or greater.

Analysis was performed on completed data sets using DRS and Enhanced Data Analysis software (Agilent Technologies, Inc.). After files were deconvoluted, they were reviewed using QEdit™ software. Peaks identified by AMDIS (Automated Mass Spectral Deconvolution and Identification System; available from the National Institute of Standards and Technology (NIST)) and Chemstation™ software were reviewed for quality. More specifically, peaks were reviewed based on comparison between library spectra, AMDIS extracted spectra and Chemstation™ spectra; qualifier peak match; and retention time. Generally peaks were considered true “hits” if they had a MF (molecular formula) match value above 75 and the three qualifier ion values were within 25% of expected. In general, a genuine match has a spectrum very similar to the library/database spectrum, shows a strong, sharp peak shape in both the Chemstation™ and AMDIS peak viewer windows, has a very high MF value, and will likely be identified by both the Chemstation™ and AMDIS softwares.

There are times when Chemstation™ integrated a different peak than AMDIS. Because AMDIS has been rigorously developed to remove erroneous background suppression and use several statistical models to effectively “mine” the data, AMDIS was given higher priority than Chemstation™ when interpreting data. When a peak was accepted as genuine, it was either left alone or manually integrated. Since the GC/MS employed for these studies only uses a single quadrupole, it often has trouble resolving overlapping peaks. In such instances, the range of the correct peak was manually integrated. Once all of the peaks had been reviewed, the data was saved and a report generated.

Reports were reviewed after analysis to ensure that data met specifications, specifically sequence data information, internal standard recovery, surrogate recovery percentages, calibrated analyte concentrations and semiquant compounds (i.e. those compounds found using AMDIS and DRS that have not been calibrated for) hits were checked. Due to limitations with the software, generated reports often listed detections for compounds that had qualifier ion mismatches. These peaks do not show up in the default view and are very difficult to track down and delete, but are always erroneous. These were simply deleted from the report.

Internal standard recovery should have a minimum abundance of 1,000,000 counts, and should generally be within 50% of the calibrated abundance. Matrix effects can cause this number to vary somewhat, so data was generally accepted even if the recovery was outside of the 50% margin.

Surrogate recoveries should also be within 50% of calibrated values, but variation may also be due to matrix effects, thus this was not generally used to reject data unless there were clear signs that the ability to generate quality data was compromised.

Semiquant compounds that were found regularly in blanks were discarded from the screening list. These compounds, which included phthalates among a few others, were ignored when reporting data. Semiquant hits were not calibrated; unless they were calibrated, they can only be reported on a presence/absence basis.

In order for calibrated compounds to be reported, they must fall within the range of the initial calibration curve. If they were outside of this range, the sample was diluted to be within this range and rerun. Calibrated compound concentrations were multiplied by the dilution factor and divided by the sample weight before being reported.

### 3. Quality Control

### (a) Evaluation of Retention Time Windows

The internal standard retention time was calibrated at 13.726 in accordance with the original AMDIS calibration. During the initial phase of calibration, the retention time was locked, which allowed AMDIS to accept or reject peaks based upon retention time. If the internal standard fell outside of the window and was not integrated by AMDIS, corrective action was taken and the sample was reanalyzed.

### (b) Sample Cleanup

Sample cleanup was performed on samples that were excessively thick or colored, or that, based on previous history, were expected to cause problems during analysis.

### (c) Handling and Storage

All standards were stored at −4° C. or below and were allowed to reach room temperature before use.

### (d) Limits of Detection

The limits of detection (LOD) determine the lowest concentration at which an analyte can be detected in an extracted sample. Since these measurements are not available for all compounds, the average of the LODs for calibrated compounds determines the estimated detection limit for uncalibrated compounds. The LOD is determined by the lowest concentration compound extracted with a signal to noise ratio of 2.5-5. These tests were performed periodically to determine any changes in instrument sensitivity.

### (e) Calibration

Initial calibration established a calibration curve used to determine the concentration of calibrated compounds and recoveries of surrogates. The average internal standard response was also used to determine the baseline response used for the internal standard calibration verification. Calibrations were run at seven levels: 0.01, 0.025, 0.05, 0.10, 0.5, 1.0, and 5.0 ppm. Using the data from this calibration, each compound should have a linear or quadratic curve with an R sq. value of 0.95 or greater. The lowest calibration level determines the limit of quantification (LOQ). If a compound failed calibration (i.e. did not have an R sq. value of 0.95 or greater) it was noted and corrected before any detections of this compound were quantitated.

Internal standard calibration verification (ISCV) was used to verify instrument performance and internal standard response. This was prepared with 1.0 ppm internal standard in methylene chloride. The internal standard abundance should be 70%-170% of the response established with the initial calibration and within the AMDIS retention time window. If the response fell outside of this window, the aberration was investigated and corrected before analysis took place. The ISCV was also used to determine column condition. The abundance of ion 207 (siloxane bleed) at 40 minutes should be under 25,000. If the background did not improve in subsequent analyses, the column was replaced and the instrument recalibrated before sample analysis.

Initial calibration verification (ICV) and continuing calibration verification (CCV) samples were used to verify that the analysis performance was within the parameters of the initial calibration. The CCV was run at the end of a set of samples to bracket either an initial calibration or ICV sample. The ICV was run in place of a set of calibration samples unless there were measures outside of limits requiring a new calibration set.

Recovery control limits for surrogates and other calibrated compounds were set at 70-170%. These laboratory control spikes calculated percent recovery. If these fall outside of limits, it could be due to matrix suppression, problems with analysis or extraction. These issues were addressed as necessary.

### 4. Testing of Sodium Ascorbate

Sodium ascorbate intended for use in nutraceuticals for human consumption was tested for the presence of multiple pesticide residues as described above. No pesticide residues in amounts above the USP <561> Articles of Botanical Origin reporting limits were found.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, method, method step or steps, for use in practicing the present invention. All such modifications are intended to be within the scope of the claims appended hereto.

All of the publications, patent applications and patents cited in this application are herein incorporated by reference in their entirety to the same extent as if each individual publication, patent application or patent was specifically and individually indicated to be incorporated by reference in its entirety.

1. A method for detecting the presence or absence of a plurality of contaminants in a sample, comprising:
(a) extracting the sample with a water-miscible solvent in the presence of a high concentration of salts to provide a sample extract;
(b) shaking and centrifuging the sample extract to provide a supernatant;
(c) exchanging the water-miscible solvent in the supernatant for an organic non-water-miscible solvent to provide a treated supernatant;
(d) analyzing the treated supernatant using gas chromatography-mass spectrometry to provide a total ion chromatogram;
(e) deconvoluting the total ion chromatogram to provide non-overlapping spectra; and
(f) comparing the non-overlapping spectra with standard mass spectra for the plurality of contaminants,
wherein the sample is a raw material for use in the preparation of a nutraceutical and wherein the standard mass spectra are contained in a retention time-locked database.

2. The method of claim 1, wherein the raw material is a mineral or plant-based material.

3. The method of claim 1, wherein the raw material is selected from those listed in Table 1.

4. The method of claim 1, wherein the water-miscible solvent is selected from the group consisting of: acetonitrile, ethyl acetate or acetone.

5. The method of claim 1, wherein the organic non-water-miscible solvent is selected from the group consisting of: methylene chloride; hexane; and toluene.

6. The method of claim 1, wherein the high concentration of salts is sufficient to provide a 60-70% composition by mass salt solution.

7. The method of claim 1, wherein the plurality of contaminants comprises at least 50, 100, 150, 200, 250, 300, 350, 400, 450, 500, 550, 600, 650, 700, 750, 800, 850 or 900 compounds listed in Table 2.
